(19) United States
(12) Patent Application Publication
(10) Pub. No.: US 2021/0178689 A1
(43) Pub. Date: Jun. 17, 2021

(54) DISPENSING POWDER

(71) Applicant: HEWLETT-PACKARD DEVELOPMENT COMPANY, L.P., Houston, TX (US)

(72) Inventors: Brent EWALD, Vancouver, WA (US); Michael RODE, Vancouver, WA (US)

(73) Assignee: HEWLETT-PACKARD DEVELOPMENT COMPANY, L.P., Houston, TX (US)

(21) Appl. No.: 16/074,404

(22) PCT Filed: Sep. 22, 2016
(86) PCT No.: PCT/US2016/053125

§ 371 Date: Jul. 31, 2018

(51) Int. Cl. B29C 64/329; B33Y 40/00; B29C 64/343; G01F 11/24

(52) U.S. Cl. CPC B29C 64/329; G01F 11/24; B29C 64/343; B33Y 40/00

(57) ABSTRACT

In one example, a device to dispense a powder includes a hopper, an outlet from the hopper, a dispenser to dispense powdered build powder from the hopper through the outlet, and an agitator movable at the outlet intermittently at the urging of the dispenser.

### BACKGROUND

Additive manufacturing machines, sometimes called 3D printers, produce objects by building up layers of material. Digital data may be processed into slices each defining that part of a layer or layers of build material to be formed into the object. In some additive manufacturing machines, the object slices are formed in a powdered build material spread in layers over the work area. Powder in each of the successive layers is fused in the desired pattern to form a solid object.

### DRAWINGS

FIG. 1 is an isometric view illustrating one example of a device to dispense powder.

FIG. 2 is an isometric partial section view of the example device shown in FIG. 1.

FIGS. 3-5 present a sequence of section views illustrating an example dispensing operation for the device of FIG. 1.

FIG. 6 is an isometric view illustrating another example of a device to dispense powder.

FIGS. 7-9 present a sequence of section views illustrating an example dispensing operation for the device in FIG. 6.

FIG. 10 is a flow diagram illustrating one example of a method to dispense powder from a supply of powder.

The same part numbers designate the same or similar parts throughout the figures. The figures are not necessarily to scale.

### DESCRIPTION

Some additive manufacturing machines are capable of using a variety of build material powders. It may be cost effective for the supply hoppers and dispensing mechanisms to accommodate the full range of powders used in such machines. Some build material powders tend to arch or rathole in the hopper, impeding the desired flow of powder at the outlet, particularly at the intermittent low flows associated with dispensing the small volumes of powder characteristic of additive manufacturing.

A new technique has been developed to help prevent unwanted arching or ratholing in powdered build material dispensers. In one example, the dispensing device includes an agitator that is movable at the outlet from the hopper intermittently at the urging of the dispenser during a dispensing operation. In one specific example, the agitator is implemented as a flexible flap that extends into the outlet of the hopper and overlaps the dispenser so that, during a dispensing operation, the dispenser pushes the flap across the outlet before releasing the flat to flex back toward the side of the outlet.

Actuating a flap or other agitator directly with the dispenser avoids the need for a discrete external drive mechanism while still breaking up powder in or near the outlet where it might otherwise more acutely impede accurately dispensing a small volume of powder. In addition, the intermittent agitation inherent in the dispenser as actuator can be effective for a variety of different powdered build materials, and helps avoid the further blockages that can be caused in some powders by vibrating agitators.

While examples implementing the new technique were developed to handle powdered build materials for additive manufacturing, examples are not limited to additive manufacturing. The examples described herein and shown in the figures illustrate but do not limit the scope of the patent, which is defined in the Claims following this Description.

As used in this document: “and/or” means one or more of the connected things; a “closer” means a dispenser configured to dispense a fixed volume of material from bulk material inside the hopper; and a “flap” means a flat flexible piece of material fixed along one part and extending to another part that is free to flex back and forth.

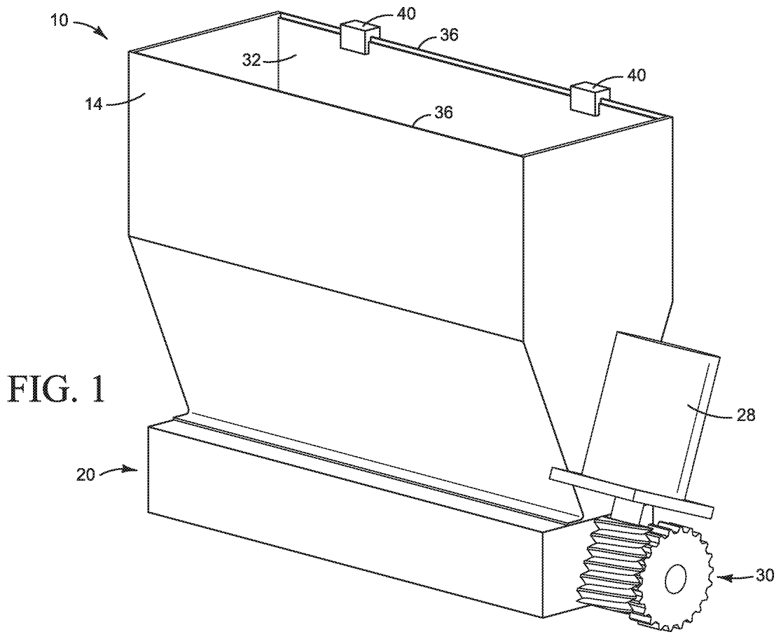

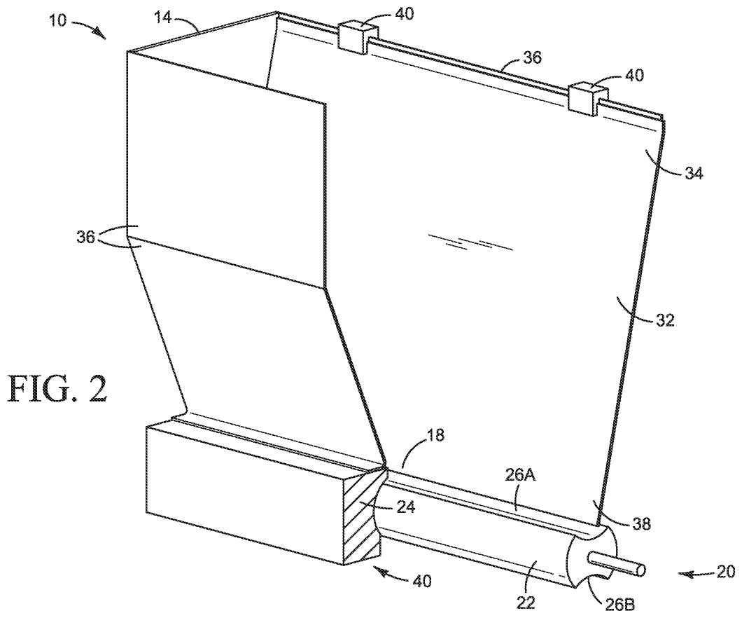

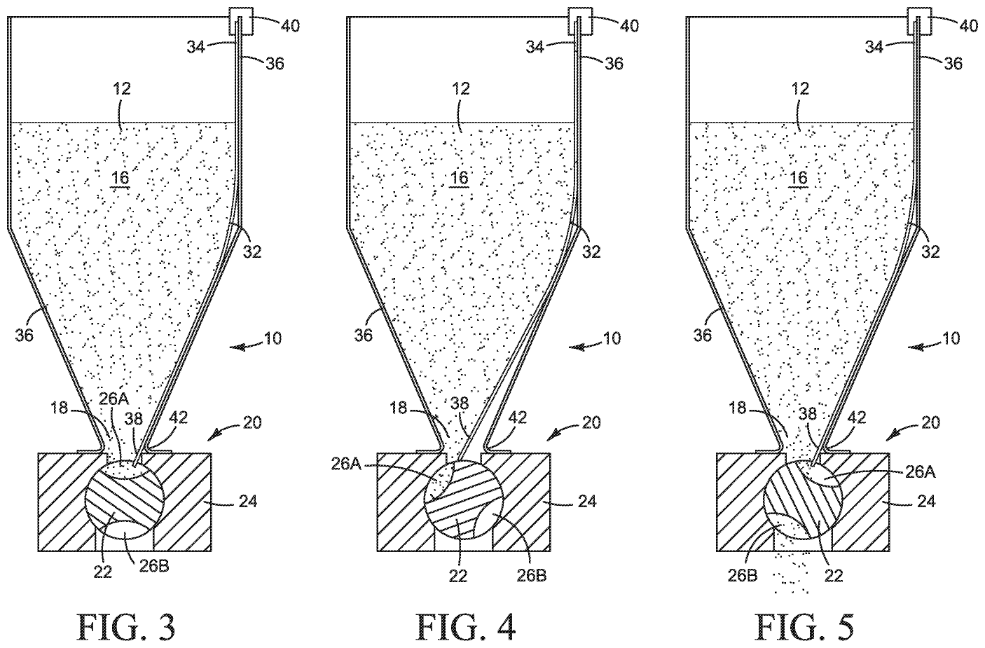

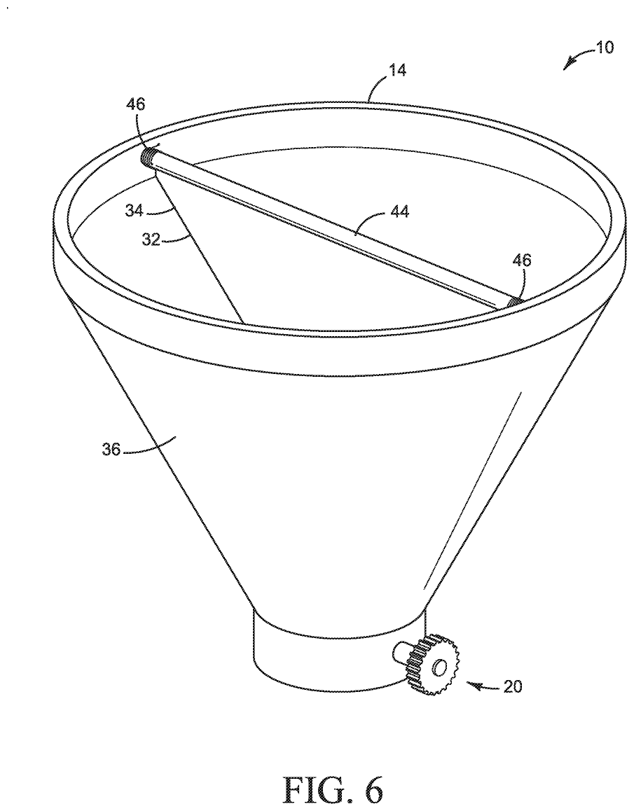

FIG. 1 is an isometric view illustrating one example of a device 10 to dispense a powder 12. FIG. 2 is an isometric partial section view of device 10 from FIG. 1. FIGS. 3-5 are section views with a supply of powder 12 in device 10. Referring to FIGS. 1-5, dispensing device 10 includes a hopper 14 to hold a supply 16 of powder 12, an outlet 18, and a dispenser 20 at outlet 18. A dispenser 20 may be attached to hopper 14 at outlet 18, for example as shown in FIGS. 1-5, or a dispenser 20 may be integrated into outlet 18 (for example as shown in FIGS. 6-9). In the example shown in FIGS. 1-5, dispenser 20 is implemented as a doser to dispense a fixed volume of powder 12 from bulk supply 16. In this example, doser 20 includes a cylindrical shaft 22 seated in a body 24. Two grooves 26A, 26B are formed in shaft 22 opposite one another to hold a dose of powder 12. Shaft 22 is turned 180° in body 24, for example with a motor 28 and drive train 30, to dispense powder 12 alternately from each groove 26A, 26B.

Dispensing device 10 also includes an agitator 32 that moves in outlet 18 intermittently at the urging of doser 20 to break up powder 12 in supply 16 at the bottom of hopper 14. In this example, agitator 32 is implemented as a flexible flap that extends from a first part 34 affixed to one sidewall 36 of hopper 14 to a second part 38 in outlet 18 overlapping doser 20. Also in this example, flap 32 is detachable, clamped to hopper 14 with clamps 40. As best seen in FIGS. 3 and 5, agitator flap 32 is positioned inside hopper 14 so that second part 38 rests against one side 42 of outlet 18 and extends into doser recess 26A (FIG. 3) or 26B (FIG. 5). If desired, flap 32 may be positioned inside hopper 14 so that the flex in the flap biases second part 38 against the side 42 of outlet 18, for example to increase a return force.

During a dispensing operation, doser shaft 22 is rotated counter-clockwise to dispense powder 12 from one recess 26A and refill the other recess 26B, as shown in the sequence of FIGS. 3-5. The rotating shaft 22 moves the second part 38 of agitator flap 32 across outlet 18, as shown in FIG. 4, until flap 32 is released at recess 26B and flexes back toward the side of outlet 18, as shown in FIG. 5. Flap 32 may be moved part way across outlet 18, as shown in FIG. 4, or fully across outlet 18. Flap 32 may be moved partially or fully across outlet 18, as desired, by varying the geometrical relationship of the parts at outlet 18. For example, extending the second part 38 of agitator flap 32 deeper into recess 26A, 26B will allow flap 32 to move further across the width of the outlet 18 during a dispensing operation. Also, flap 32 may be located toward the interior of hopper 14 rather than at the side of hopper 14. For example, it may be desirable in some implementations to locate flap 32 at the center of hopper 14 to accommodate a doser shaft 22 that rotates bidirectionally (clockwise and counterclockwise) for dispensing.

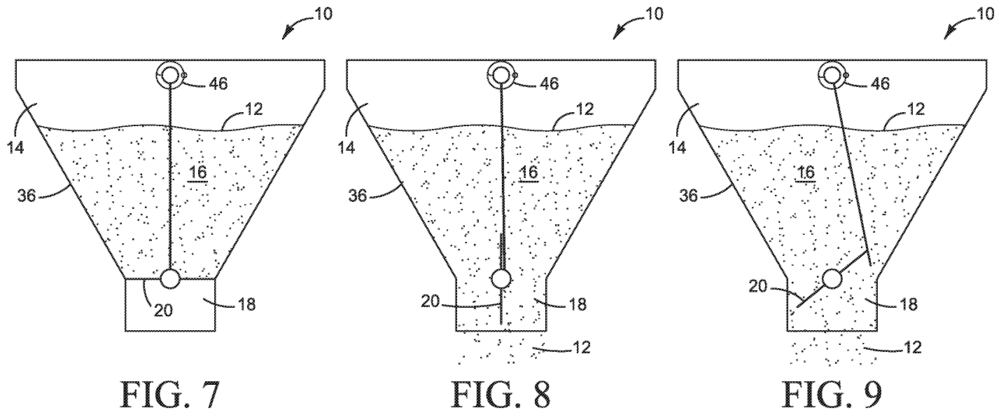

FIG. 6 is an isometric view illustrating another example of a device 10 to dispense powder 12. FIGS. 7-9 are section views with a supply of powder 12 in device 10. In the example shown in FIGS. 6-9, device 10 includes a conical hopper 14 with a dispenser 20 implemented as a valve that opens and closes outlet 18 to dispense powder 12 from bulk supply 16. Also in this example of dispensing device 10, agitator 32 is implemented as a plate that pivots back and forth on a shaft or other suitable pivot 44. Agitator plate 32 includes a first part 34 attached to pivot 44 and a second part 38 that extends in to outlet 18 and overlaps valve 20. During a dispensing operation, valve 20 is rotated 90° clockwise to open outlet 18, as shown in FIGS. 7 and 8. As valve 20 is rotated clockwise from the open position shown in FIG. 8 toward the closed position (shown in FIG. 7), the rotating valve 20 moves the second part 38 of agitator plate 32 across outlet 18, as shown in FIG. 9, until plate 20 is released and pivots back toward the center of outlet 18 at the urging of a return spring 46.

The extent of travel of agitator plate 32 back and forth across outlet 18 may be varied by changing the geometrical relationship of the parts at outlet 18. For example, the extent of travel may be lengthened from that shown by biasing plate 32 toward the left side of outlet 18 so that valve 20 engages and moves plate 32 across outlet 18 when opening as well as when closing. Also, opposing torsion springs 46 or other suitable biasing devices may be used to provide a return force in both directions, thus accommodating valve 20 opening and closing clockwise and/or counter-clockwise.

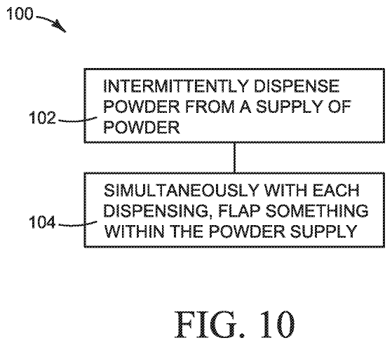

FIG. 10 is a flow diagram illustrating one example of a method 100 to dispense powder from a supply of powder, such as might be executed with a dispensing device 10 shown in FIGS. 1-5. Part numbers in the description of method 100 are made with reference to the example device 10 shown in FIGS. 1-5. However, method 100 may be executed with other dispensing devices. Referring to FIG. 10, powder 12 is intermittently dispensed from a supply 16 (block 102) and, simultaneously with each dispensing, something is flapped within the powder supply 16 (block 104). For example, the flapping may be executed by a doser 20 moving an agitator flap 32 one way and the flap flexing back the other way as shown in FIGS. 4 and 5. Intermittently flapping something within the powder supply simultaneously with each dispensing operation helps keep the powder loose for dispensing without constant agitation.

As noted above, the examples shown in the figures and described herein illustrate but do not limit the patent, which is defined in the following Claims.

“A”, “an” and “the” used in the claims means one or more. For example, “a flap” means one or more flaps and “the flap” means the one or more flaps.

1. A device to dispense a powder, comprising:
a hopper having sidewalls that extend toward an outlet;
a dispenser at the outlet, the dispenser movable between a first position in which powder is not dispensed from the outlet and a second position in which powder is dispensed from the outlet; and
a flap inside the hopper upstream from the dispenser in a direction powder leaves the hopper through the outlet, the flap movable by the dispenser across the hopper when the dispenser is moved from a first position toward a second position and/or from a second position toward a first position.

2. The device of claim 1, where the flap includes a fixed first part away from the dispenser and a movable second part overlapping the dispenser such that:
the dispenser moves the second part of the flap across the hopper when the dispenser is moved from a first position toward a second position and/or from a second position toward a first position; and
the dispenser releases the second part of the flap to flex back across the hopper as the dispenser continues to be moved from a first position toward a second position and/or from a second position toward a first position.

3. The device of claim 1, where the flap is movable by the dispenser partially across the hopper.

4. The device of claim 1, where the dispenser comprises a doser movable between a first position in which the doser holds a fixed volume of powder and a second position in which the doser dispenses the fixed volume of powder from the hopper through the outlet.

5. The device of claim 1, where the dispenser comprises a valve integral to the outlet and movable between a first, closed position in which powder in the hopper may not flow through the outlet and a second, open position in which powder in the hopper may flow through the outlet.

6. The device of claim 2, where the second part of the flap is clamped to one of the sidewalls of the hopper.

7. A device to dispense a powder, comprising:
a hopper;
an outlet from the hopper;
a dispenser to dispense powdered build powder from the hopper through the outlet; and
an agitator movable at the outlet intermittently at the urging of the dispenser.

8. The device of claim 7, where the agitator is movable:
at the urging of the dispenser, from a first position at one side of the outlet part way across the outlet to a second position; and
to flex or pivot from the second position toward the first position.

9. The device of claim 7, where the agitator comprises a pivotable agitator having a first part attached to a pivot and a second part away from the pivot and extending in to the outlet, the second part of the agitator movable in the outlet at the urging of the dispenser.

10. The device of claim 7, where:
the agitator comprises a flexible flap that includes a fixed first part away from the dispenser and a movable second part extending into the outlet;
the dispenser is to move the second part of the flap across the outlet from a first position at one side of the outlet to a second position; and
the dispenser is to release the second part of the flap to flex back from the second position toward the first position.

11. A method, comprising:
intermittently dispensing powder through an outlet from a supply of powder; and
simultaneously with each dispensing, flapping something within the supply at the outlet.

12. The method of claim 11, where the dispensing includes dosing powder from the supply.

13. The method of claim 12, where the flapping includes a doser moving a flap one way and the flap flexing back the other way.

14. The method of claim 13, where the dosing includes rotating a doser to move the flap and dispense the powder.
